(19) United States
(12) Patent Application Publication
(10) Pub. No.: US 2024/0085539 A1
(43) Pub. Date: Mar. 14, 2024

(54) LIDAR DEVICE

(71) Applicants: DENSO CORPORATION, Kariya-city, Aichi-pref. (JP); TOYOTA JIDOSHA KABUSHIKI KAISHA, Toyota-shi, Aichi-ken (JP); MIRISE Technologies Corporation, Nisshin-shi, Aichi-ken (JP)

(72) Inventors: Masashige SATO, Nisshin-shi (JP); Taku SUZUKI, Nisshin-shi (JP)

(21) Appl. No.: 18/337,670

(22) Filed: Jun. 20, 2023

(30) Foreign Application Priority Data
Jun. 22, 2022 (JP) 2022-100232

(51) Int. Cl. G01S 7/4912; G01S 17/89

(52) U.S. Cl. CPC G01S 7/4912; G01S 17/89

(57) ABSTRACT

A LIDAR device includes a transmission unit, a scanning unit, a reception unit, a data conversion unit, a data holding unit, a frequency analysis unit configured to execute frequency analysis to acquire ranging point data, and a point group generator configured to generate a group of ranging points acquired by using a result of frequency analysis on a first analysis target data set and a group of ranging points acquired by using a result of frequency analysis on a second analysis target data set.

### CROSS REFERENCE TO RELATED APPLICATION

This application is based on Japanese Patent Application No. 2022-100232 filed on Jun. 22, 2022, the disclosure of which is incorporated herein by reference.

### TECHNICAL FIELD

The present disclosure relates to a LIDAR device.

### BACKGROUND

There is a technique of measuring a distance to an object by using a phase difference between a continuous wave transmitted and modulated with passage of time and a reflected wave reflected from the object.

### SUMMARY

According to one aspect of the present disclosure, a LIDAR device includes: a transmission unit configured to transmit a transmission wave modulated by a modulation capable of arbitrarily setting a sampling interval; a scanning unit configured to scan the transmission wave within a predetermined range of a scanning angle; a reception unit configured to receive a reflected wave that is the transmission wave reflected by an object; a data conversion unit configured to convert the reflected wave received within the predetermined range of the scanning angle into sampling data; a data holding unit configured to hold the sampling data; a frequency analysis unit; and a point group generator. The frequency analysis unit is configured to execute frequency analysis on at least one first analysis target data set and a plurality of second analysis target data set, and to acquire ranging point data including information at least on a distance and a direction of a ranging point with respect to the LIDAR device by using a result of the frequency analysis. The at least one first analysis target data set is obtained by reading the sampling data from the data holding unit for each first angle range that is equal to or less than the scanning angle. The plurality of second analysis target data set is obtained by reading the sampling data for each second angle range smaller than the first angle range. The point group generator is configured to generate a group of ranging points indicated by the ranging point data acquired by using the result of the frequency analysis on the first analysis target data set and a group of ranging points indicated by the ranging point data acquired by using the result of the frequency analysis on the second analysis target data set.

### BRIEF DESCRIPTION OF THE DRAWINGS

FIG. 1 is an explanatory diagram illustrating a schematic configuration of a LIDAR device according to a first embodiment.

FIG. 2 is an explanatory diagram illustrating a procedure of an object detection process according to the first embodiment.

FIG. 3 is an explanatory diagram illustrating a range of reading sampling data for each data set.

FIG. 4 is an explanatory diagram illustrating a procedure of a ranging point output process.

FIG. 5 is an explanatory diagram illustrating a procedure of an object detection process according to a second embodiment.

FIG. 6 is an explanatory diagram illustrating a procedure of an object detection process according to a third embodiment.

### DESCRIPTION OF EMBODIMENTS

Conventionally, there is a technique of measuring a distance to an object by using a phase difference between a continuous wave transmitted and modulated with passage of time and a reflected wave reflected from the object. The measurement efficiency is restricted from decreasing by changing the resolution in accordance with the distance to the object.

However, in the distance measuring system, the object may not be detected in a situation where the SN ratio is low, such as when the distance to the object is long or when the reflectance of the object is low. In addition, if the measurement time is lengthened in order to detect the object in such a situation, the resolution is lowered and the position of the object cannot be accurately specified.

The present disclosure may be provided by the following aspect or embodiments.

According to one aspect of the present disclosure, a LIDAR device includes: a transmission unit configured to transmit a transmission wave modulated by a modulation method capable of arbitrarily setting a sampling interval; a scanning unit configured to scan the transmission wave within a predetermined range of a scanning angle; a reception unit configured to receive a reflected wave that is the transmission wave reflected by an object; a data conversion unit configured to convert the reflected wave received within the predetermined range of the scanning angle into sampling data; a data holding unit configured to hold the sampling data; a frequency analysis unit; and a point group generator. The frequency analysis unit is configured to execute frequency analysis on at least one first analysis target data set and a plurality of second analysis target data set, and to acquire ranging point data including information at least on a distance and a direction of a ranging point with respect to the LIDAR device by using a result of the frequency analysis. The at least one first analysis target data set is obtained by reading the sampling data from the data holding unit for each first angle range that is equal to or less than the scanning angle. The plurality of second analysis target data set is obtained by reading the sampling data for each second angle range smaller than the first angle range. The point group generator is configured to generate a point group of a plurality of ranging points indicated by the ranging point data acquired by using the result of the frequency analysis on the first analysis target data set and a point group of a plurality of ranging points indicated by the ranging point data acquired by using the result of the frequency analysis on the second analysis target data set.

The present disclosure can be realized as the following embodiments. For example, the present disclosure can be realized in a vehicle including a LIDAR device, an object detection method, a computer program for realizing the device and method, a storage medium storing such a computer program, and the like.

### First Embodiment

A light detection and ranging (LIDAR) device 100 according to the present embodiment measures a distance, direction, and relative speed of an object with respect to the LIDAR device 100. Specifically, the LIDAR device 100 emits laser light as a transmission wave and detecting a reflected wave that is the transmission wave being reflected by the object. The LIDAR device 100 of the present embodiment is mounted on a vehicle and detects an object around the vehicle, for example, another vehicle, a pedestrian, a building, or the like.

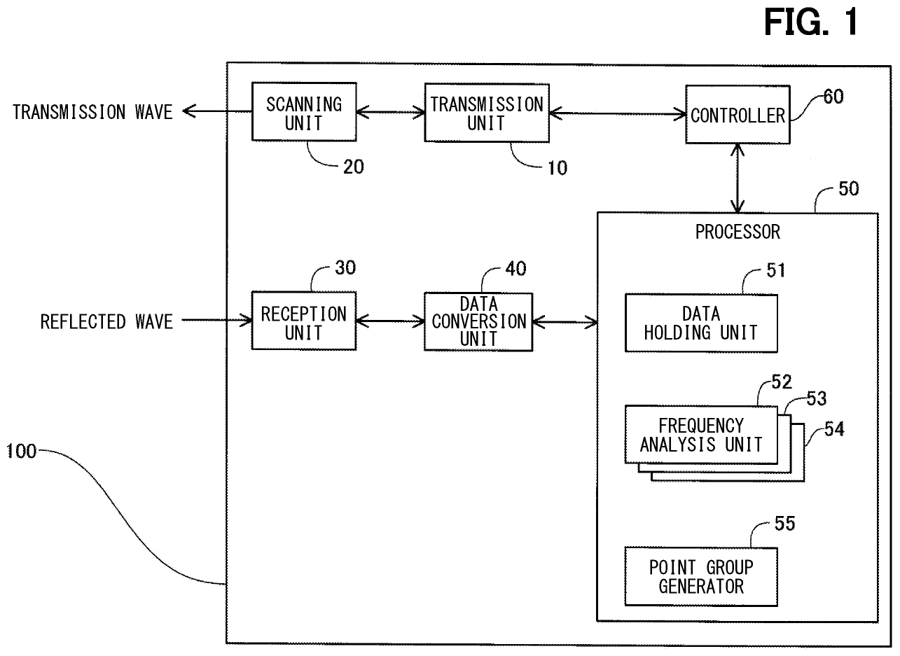

As illustrated in FIG. 1, the LIDAR device 100 includes a transmission unit 10, a scanning unit 20, a reception unit 30, a data conversion unit 40, a processor 50, and a controller 60. The processor 50 includes a data holding unit 51, plural frequency analysis units 52 to 54, and a point group generator 55.

The transmission unit 10 generates a transmission wave and transmits the transmission wave. In the present embodiment, the transmission unit 10 transmits two types of transmission waves in parallel, that is, a transmission wave whose frequency is modulated to increase with time and a transmission wave whose frequency is modulated to decrease with time. By transmitting the transmission waves in such a manner, the position and speed of the target object can be measured even when sampling data is taken out in an arbitrary sampling section. Further, by driving the scanning unit 20, the scanning unit 20 can continuously transmit the transmission wave within a predetermined range of scanning angle.

The reception unit 30 receives a reflected wave generated by the transmission wave being reflected by an object existing in the transmission direction of the transmission wave. The data conversion unit 40 acquires sampling data at a preset sampling frequency from a frequency difference signal (hereinafter, referred to as a beat signal) between the reflected wave and the transmitted wave. The sampling frequency is set to be at least twice the maximum frequency by the beat signal, which is specified in advance by experiments. The sampling data is held in the data holding unit 51.

The frequency analysis units 52 to 54 acquire ranging point data using a frequency spectrum obtained by performing frequency analysis on the sampling data read from the data holding unit 51 in a ranging point output process to be described later. In the present embodiment, the frequency analysis unit 52 performs fast Fourier transform (FFT). In the present embodiment, the ranging point data includes at least information on the distance, direction, and relative speed of the object with respect to the LIDAR device 100.

The point group generator 55 generates a point cloud by mapping plural ranging points indicated by the ranging point data obtained in a ranging point output process. The ranging point represents a point at which the transmission wave is reflected within the range of the scanning angle.

The controller 60 is configured as a logic circuit mainly including a microcomputer. More specifically, the controller 60 includes a CPU that executes calculation and the like in accordance with a preset control program, a ROM in which a control program, control data, and the like necessary for executing various calculation processes in the CPU are stored in advance, a RAM in which various data necessary for executing various calculation processes in the CPU are temporarily read and written, a port unit that inputs and outputs various signals, and the like. The controller 60 controls the LIDAR device 100 in the object detection process.

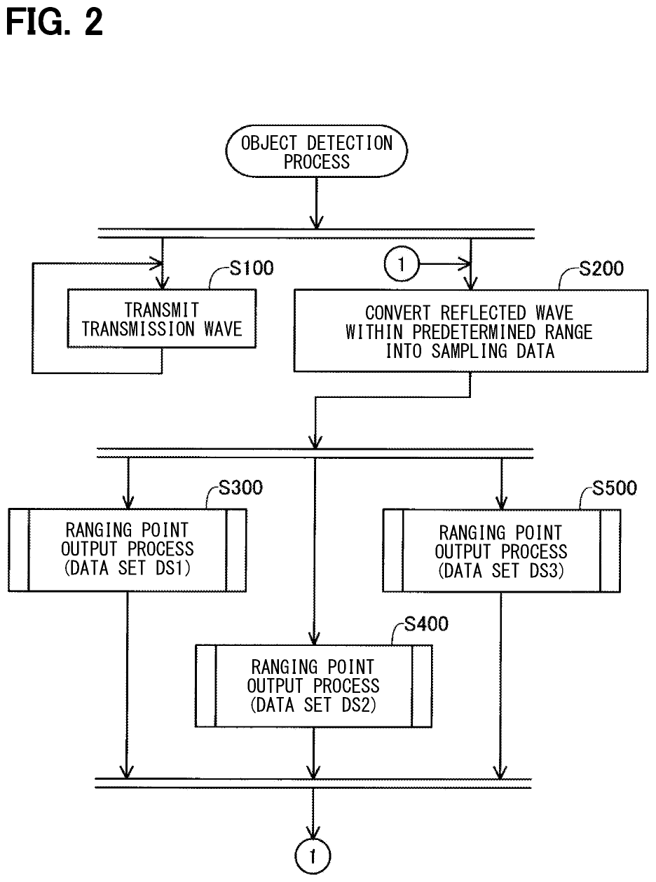

The LIDAR device 100 according to the present embodiment executes the object detection process illustrated in FIG. 2 to detect other vehicles, pedestrians, buildings, and the like existing around the vehicle. In S100 of FIG. 2, the transmission unit 10 transmits a transmission wave within a predetermined range of scanning angle. The LIDAR device 100 repeatedly executes this step while the vehicle is traveling.

In parallel with S100, when the reception unit 30 receives the reflected wave in the predetermined range of the scanning angle, the data conversion unit 40 converts the received reflected wave into sampling data (S200). In the present embodiment, upon receiving a reflected wave in an angle range of 0.6°, the LIDAR device 100 converts the received reflected wave into sampling data. The converted sampling data is held in the data holding unit 51.

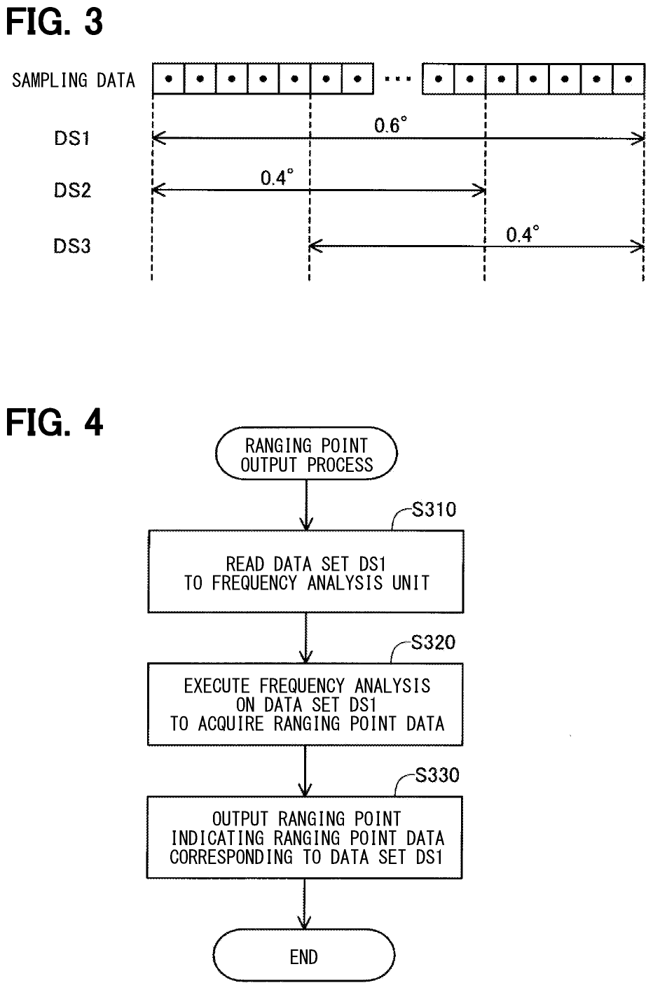

The LIDAR device 100 executes the ranging point output process (S300) for the data set DS1, the ranging point output process (S400) for the data set DS2, and the ranging point output process (S500) for the data set DS3 in parallel. The data set DS1 is obtained by reading sampling data for each preset first angle range. The data set DS1 corresponds to a first analysis target data set in the present disclosure. The data set DS2 and the data set DS3 are obtained by reading sampling data for each predetermined second angle range smaller than the first angle range. The data set DS2 and the data set DS3 correspond to a second analysis target data set in the present disclosure. In the present embodiment, as illustrated in FIG. 3, the first angle range is 0.6° and corresponds to a data set obtained by reading the entire sampling data converted in S200 of FIG. 2. The second angle range of the present embodiment is 0.4°, and the data set DS2 and the data set DS3 include data mutually overlapping with each other.

In the present embodiment, in a ranging point output process to be described later, the LIDAR device 100 executes frequency analysis on the data set DS1 in the frequency analysis unit 52, frequency analysis on the data set DS2 in the frequency analysis unit 53, and frequency analysis on the data set DS3 in the frequency analysis unit 54. Since the LIDAR device 100 executes the same processing in the ranging point output process for any data set, the ranging point output process for the data set DS1 illustrated in FIG. 4 will be described as an example in the following description.

In S310, the LIDAR device 100 reads the data set DS1 to the frequency analysis unit 52.

In S320, the frequency analysis unit 52 performs frequency analysis on the data set DS1 to acquire ranging point data. As described above, the frequency analysis unit 52 acquires ranging point data using a frequency spectrum obtained by performing frequency analysis on the data set DS1. Note that the frequency analysis executed in this step is the same processing as the frequency analysis executed in the distance measurement of the frequency modulated continuous wave (FMCW) method in general.

In S330, the point group generator 55 outputs a ranging point indicating the ranging point data corresponding to the data set DS 1. After the end of this step, the ranging point output process for the data set DS1 ends.

As shown in FIG. 2, after the end of the ranging point output process for all of the data sets DS1 to DS3, the LIDAR device 100 executes S200 again. While the vehicle is traveling, the LIDAR device 100 repeatedly executes the processes of S200 to S500 each time a reflected wave within a preset angle range is received. In this way, the LIDAR device 100 specifies the position of the object existing within the range of the scanning angle by repeatedly executing the above-described processing and outputting plural ranging points to generate a point group.

According to the LIDAR device 100, even an object having a low SN ratio can be detected with high sensitivity by frequency analysis targeting the data set DS1. Further, an object having a high SN ratio can be detected with high resolution by frequency analysis targeting the data set DS2 and the data set DS3. Therefore, it is possible to suppress a decrease in sensitivity and resolution of object detection.

Since the data set DS2 and the data set DS3 include data mutually overlapping with each other in an angular range, it is possible to reduce the possibility that data indicating the presence of an object in the sampling data is divided into two different data sets, such that the object can be appropriately detected.

Since the LIDAR device 100 includes the three frequency analysis units 52 to 54, it is possible to execute the frequency analysis on the analysis target data sets different from each other in parallel in the corresponding frequency analysis units. Thus, it is possible to suppress a decrease in the processing performance of the LIDAR device 100.

### Second Embodiment

The LIDAR device 100 of the second embodiment is different from the LIDAR device 100 of the first embodiment in that the readout angle is set according to the peak intensity of the reflected wave in the result of the frequency analysis on the data set DS1 and the sampling data is read for each range of the readout angle.

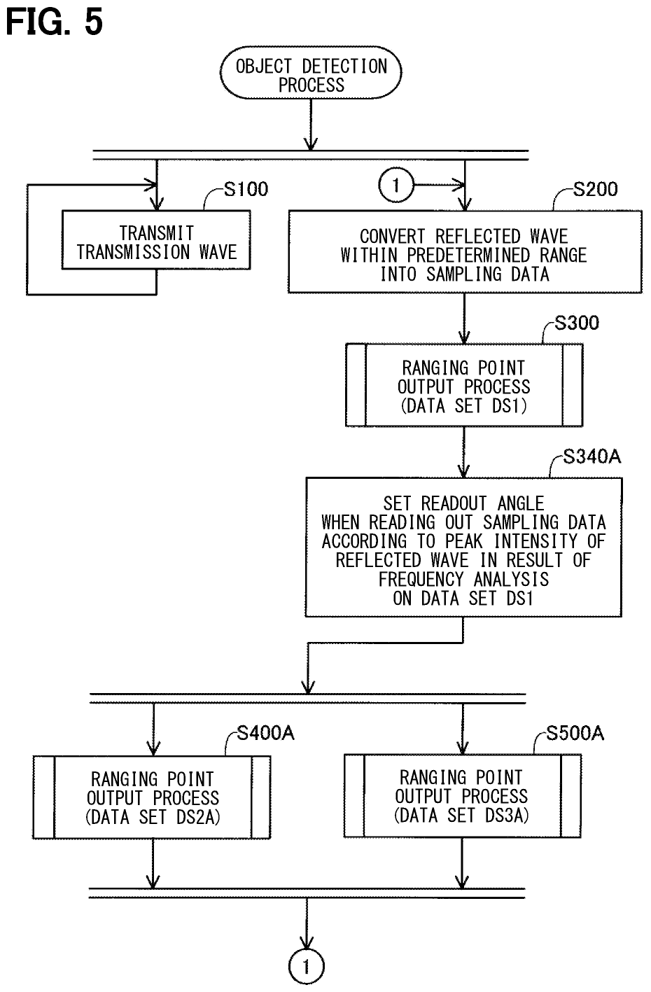

As illustrated in FIG. 5, after S200, the LIDAR device 100 executes a ranging point output process for the data set DS1 (S300) prior to a ranging point output process for the data set DS2A and the data set DS3A to be described later.

In S340A, the LIDAR device 100 sets a readout angle at the time of reading out the sampling data according to the peak intensity of the reflected wave in the result of the frequency analysis on the data set DS 1. For example, when the peak intensity is 6 times the preset threshold value, the LIDAR device 100 sets the third angle range, which is 1/6 of the first angle range, as the readout angle. When the peak intensity is large, there is a high possibility that the SN ratio of the object is high. Therefore, in this case, the position of the object can be identified with a smaller number of pieces of sampling data than when the SN ratio of the object is low. Therefore, in the present embodiment, the third angle range smaller than the second angle range is set as the readout angle.

The LIDAR device 100 executes, in parallel, the ranging point output process (S400A) for the data set DS2A and the ranging point output process (S500A) for the data set DS3A. The data set DS2A and the data set DS3A are obtained by reading sampling data for each third angle range. The data set DS2A and the data set DS3A correspond to a third analysis target data set in the present disclosure.

According to the LIDAR device 100 of the second embodiment, the readout angle is set according to the peak intensity of the reflected wave in the result of the frequency analysis on the data set DS1, and the sampling data is read for each range of readout angle. Accordingly, it is possible to perform measurement with an appropriate resolution for each SN ratio of the object, and it is possible to further suppress a decrease in sensitivity and resolution of object detection.

### Third Embodiment

The LIDAR device 100 of the third embodiment is different from the LIDAR device 100 of the second embodiment in that a thinning interval is set according to the peak frequency of the reflected wave in the result of the frequency analysis on the data set DS1 and the sampling data is read at the thinning interval.

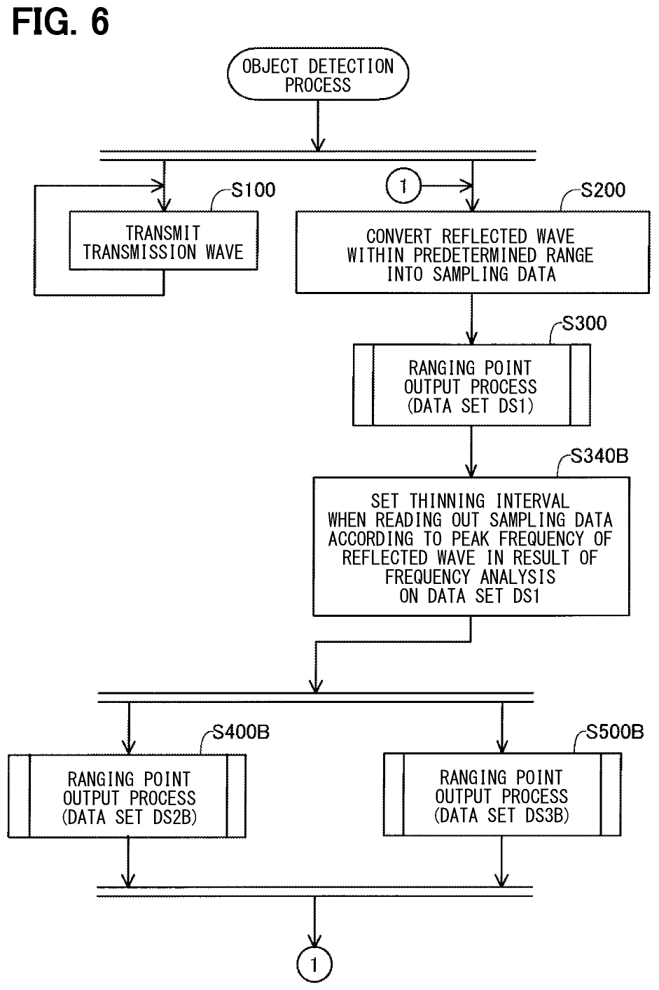

As illustrated in FIG. 6, after the ranging point output process (S300) for the data set DS1, the LIDAR device 100 sets the thinning interval at the time of reading out the sampling data according to the peak frequency of the reflected wave in the result of the frequency analysis on the data set DS1 (S340B). For example, when the peak frequency is equal to or less than ¼ of the sampling frequency, the LIDAR device 100 sets the thinning interval as “1”. When the thinning interval is set to “1”, the frequency analysis unit 53 and the frequency analysis unit 54 read the sampling data “every other point” in the subsequent ranging point output process. Even in this case, the effective sampling frequency is twice or more the peak frequency. Therefore, when the sampling frequency is twice or less the frequency of the measurement target signal, it is possible to suppress the occurrence of the aliasing phenomenon in which the frequency of the measurement target signal is detected as a value different from the actual value.

The LIDAR device 100 executes, in parallel, the ranging point output process (S400B) for the data set DS2B and the ranging point output process (S500B) for the data set DS3B. The data set DS2B and the data set DS3B are obtained by reading the sampling data for each second angle range with the thinning interval. The data set DS2B and the data set DS3B correspond to a second analysis target thinned data set in the present disclosure.

According to the LIDAR device 100 of the third embodiment, the thinning interval is set according to the peak frequency of the reflected wave in the result of the frequency analysis on the data set DS1, and the sampling data is read at the thinning interval. As a result, the frequency analysis can be executed with a small number of data, and a decrease in the processing performance of the LIDAR device 100 can be suppressed.

### Other Embodiment

In the above embodiment, the transmission unit 10 transmits two types of transmission waves in parallel, that is, a transmission wave whose frequency is modulated to increase as time elapses and a transmission wave whose frequency is modulated to decrease as time elapses, but the present disclosure is not limited thereto. The transmission unit 10 may transmit a transmission wave modulated by a modulation method in which a sampling period can be arbitrarily set, which is not limited to the above-described modulation method. For example, the transmission unit 10 may transmit a transmission wave whose frequency and amplitude are modulated as time elapses.

(D2) In the above embodiment, the LIDAR device 100 reads a data set corresponding to the entire sampling data as the first analysis target data set, but the present disclosure is not limited thereto. The LIDAR device 100 may set an angle smaller than the angle at which the reflected wave is received in S200 as the first angle range, and may set a plurality of data sets obtained by reading the sampling data for each first angle range as the first analysis target data sets.

(D3) In the above embodiment, the LIDAR device 100 executes the ranging point output process every time a reflected wave in a preset angle range is received, but the present disclosure is not limited thereto. The LIDAR device 100 may execute the ranging point output process after receiving the reflected wave in the entire range of the scanning angle.

(D4) In the above embodiment, the data set DS2 and the data set DS3 include data mutually overlapping with each other in the angular range, but the present disclosure is not limited thereto. The data set DS2 and the data set DS3 may not mutually overlap with each other in the angular range. According to this aspect, since the number of pieces of data to be subjected to the frequency analysis is reduced for each data set, it is possible to suppress a decrease in the processing performance of the LIDAR device 100.

(D5) In the above embodiment, the LIDAR device 100 includes the three frequency analysis units 52 to 54, but the present disclosure is not limited thereto. The LIDAR device 100 may include only one frequency analysis unit. According to this aspect, since the frequency analysis for the plural data sets is executed not in parallel but in order, it is possible to suppress complication of the frequency analysis in the object detection process.

(D6) In the above embodiment, the LIDAR device 100 performs the ranging point output process on the data set DS1, the data set DS2, and the data set DS3, but the present disclosure is not limited thereto. The LIDAR device 100 may further perform a ranging point output process on plural data sets obtained by reading sampling data for each range of angle smaller than the first angle range and different from the second angle range. According to this aspect, since the possibility that the frequency analysis can be executed with an appropriate number of pieces of sampling data with respect to the SN ratio of the object increases, it is possible to suppress a decrease in the sensitivity and resolution of the object detection.

(D7) In the second embodiment, the LIDAR device 100 sets one readout angle according to the peak intensity of the reflected wave in the result of the frequency analysis on the data set DS1, but the present disclosure is not limited thereto. When there are plural peaks of the reflected wave in the result of the frequency analysis on the data set DS1, the LIDAR device 100 may set plural readout angles according to the intensity of each peak. For example, in a case where there is a peak whose peak intensity is six times the threshold value and a peak whose peak intensity is twice the threshold value, the LIDAR device 100 may set, as the readout angle, two angles, one of which has a magnitude of 1/6 of the first angle range and the other has a magnitude of 1/2 of the first angle range. Further, the LIDAR device 100 may execute the ranging point output process on plural data sets obtained by reading the sampling data for each set angle range. According to this aspect, it is possible to suppress a decrease in sensitivity and resolution of object detection in measurement of plural objects.

(D8) In the second embodiment, the LIDAR device 100 executes the ranging point output process on the data set DS2A and the data set DS3A instead of the data set DS2 and the data set DS3, but the present disclosure is not limited thereto. The LIDAR device 100 may perform the ranging point output process on the data set DS2A and the data set DS3A in addition to the data set DS2 and the data set DS3.

(D9) In the third embodiment, the LIDAR device 100 executes the ranging point output process on the data set DS2B and the data set DS3B instead of the data set DS2 and the data set DS3, but the present disclosure is not limited thereto. In addition to the data set DS2 and the data set DS3, the LIDAR device 100 may perform the ranging point output process on the data set DS2B and the data set DS3B.

The present disclosure should not be limited to the embodiments described above, and various other embodiments may be implemented without departing from the scope of the present disclosure. For example, the technical features in each embodiment corresponding to the technical features can be appropriately replaced or combined in order to solve a part or all of the above-described issues or achieve a part or all of the above-described effects. Also, some of the technical features may be omitted as appropriate.

The controller and the techniques thereof according to the present disclosure may be implemented by one or more special-purposed computers. Such a special-purposed computer may be provided (i) by configuring (a) a processor and a memory programmed to execute one or more functions embodied by a computer program. Alternatively, the controller and the like and the method thereof described in the present disclosure may be achieved by a dedicated computer provided by configuring a processor with one or more dedicated hardware logic circuits. Alternatively, the controller and the like and the method thereof described in the present disclosure may be achieved by one or more dedicated computers configured by a combination of a processor and a memory programmed to execute one or more functions and a processor configured by one or more hardware logic circuits. The computer program may be stored, as instructions to be executed by a computer, in a tangible non-transitory computer-readable medium.

What is claimed is:

1. A LIDAR device comprising:
a transmission unit configured to transmit a transmission wave modulated by a modulation in which a sampling interval is to be set;
a scanning unit configured to scan the transmission wave within a predetermined range of a scanning angle;
a reception unit configured to receive a reflected wave that is the transmission wave reflected by an object;
a data conversion unit configured to convert the reflected wave received within the predetermined range of the scanning angle into sampling data;
a data holding unit configured to hold the sampling data;
a frequency analysis unit configured to perform frequency analysis on at least one first analysis target data set and a plurality of second analysis target data sets so as to acquire ranging point data including information at least on a distance and a direction of a ranging point with respect to the LIDAR device by using a result of the frequency analysis, the at least one first analysis target data set being obtained by reading the sampling data from the data holding unit for each range of first angle that is equal to or less than the scanning angle, the plurality of second analysis target data sets being obtained by reading the sampling data for each range of second angle smaller than the first angle; and
a point group generator configured to generate a group of a plurality of ranging points indicated by the ranging point data acquired by using the result of the frequency analysis on the first analysis target data set and a group of a plurality of ranging points indicated by the ranging point data acquired by using the result of the frequency analysis on the second analysis target data set.

2. The LIDAR device according to claim 1, wherein
the plurality of second analysis target data sets includes at least two second analysis target data sets obtained by reading the sampling data for two ranges of the second angle that partially overlap with each other.

3. The LIDAR device according to claim 1, wherein
the frequency analysis unit is one of a plurality of frequency analysis units, and
the plurality of frequency analysis units executes the frequency analysis respectively on the second analysis target data sets different from each other in parallel.

4. The LIDAR device according to claim 1, wherein
when a peak intensity of the reflected wave in the result of the frequency analysis on the first analysis target data set is equal to or greater than a preset threshold value, the frequency analysis unit executes the frequency analysis on a plurality of third analysis target data sets obtained by reading the sampling data for each range of third angle smaller than the second angle, instead of the second analysis target data set, to acquire the ranging point data.

5. The LIDAR device according to claim 4, wherein
the plurality of third analysis target data sets includes at least two third analysis target data sets obtained by reading the sampling data for two ranges of the third angle that partially overlap with each other.

6. The LIDAR device according to claim 4, wherein
the frequency analysis unit is one of a plurality of frequency analysis units, and
the plurality of frequency analysis units executes the frequency analysis respectively on the third analysis target data sets different from each other in parallel.

7. The LIDAR device according to claim 1, wherein
the frequency analysis unit is configured to set a thinning interval according to a peak frequency of the reflected wave in a result of the frequency analysis on the first analysis target data set, and
the frequency analysis unit executes the frequency analysis on a plurality of second analysis target thinned data sets obtained by reading the sampling data for each range of the second angle at the thinning interval, instead of the second analysis target data set, to acquire the ranging point data.

8. The LIDAR device according to claim 7, wherein
the plurality of second analysis target thinned data sets includes at least two second analysis target thinned data sets obtained by reading the sampling data for two ranges of the second angle that partially overlap with each other.

9. The LIDAR device according to claim 7, wherein
the frequency analysis unit is one of a plurality of frequency analysis units, and
the plurality of frequency analysis units executes the frequency analysis respectively on the second analysis target thinned data sets different from each other in parallel.
